(19) United States
(12) Patent Application Publication
(10) Pub. No.: US 2005/0154634 A1
(43) Pub. Date: Jul. 14, 2005

(54) Human factors scheduling safety system

(76) Inventor: Robert Konop, Playa del Rey, CA (US)

Correspondence Address: Robert C. Konop, P.O. Box 5065, Playa del Rey, CA, 90296, US

(21) Appl. No.: 10/795,463

(22) Filed: Mar. 7, 2004

Related U.S. Application Data
(60) Provisional application No. 60/453,236, filed on Mar. 8, 2003.

(51) Int. Cl. G06F 17/60

(52) U.S. Cl. 705/11

(57) ABSTRACT

A method of scheduling, schedule evaluation, and records-keeping in which various accumulated Fatigue Factors are summed, compared to elsewhere established limits, then evaluated in terms of the rest necessary to return an individual to service for additional work tasks or duty. The intervening Rest Factors are also evaluated in terms of whether a subsequent return to additional work tasks, or duty, will be restricted or unrestricted, depending on the quality and quantity of intervening rest.

### CROSS-REFERENCE TO RELATED APPLICATIONS

60/453,236—Mar. 8, 2003

### FEDERALLY SPONSORED RESEARCH

Not Applicable

### SEQUENCE LISTING OR PROGRAM

Not Applicable

### BACKGROUND OF THE INVENTION

1. Field of Invention

This is a business method invention defining a personnel scheduling system to ensure that working personnel will not accumulate fatigue which will exceed predetermined levels, beyond those which are safe and/or efficient.

2. Background of the Invention

The transportation, health care, public utilities, public safety, and any number of other industries which rely on alert human actions to accomplish a particular task, suffer from archaic scheduling practices. Those scheduling practices are universally centered on the assignment of personnel based on an arbitrary limitation on working hours, to a point which is generally associated with degraded performance. The purpose of these established limitations, whether by regulation, contract, or accepted standard, is to avoid creating dangerous fatigue situations and/or situations in which productivity is seriously degraded. The arbitrary limitation of work hours, however, is a compromise which addresses only one element of an entire body Fatigue Factors which affect working personnel, in terms of both safety and productivity.

Whether it is an Emergency Room doctor, an Airline Pilot, a Trucker, or a Nuclear Reactor Operator, the fatigue which impacts the level of accuracy in task accomplishment is induced through the interaction of a complex set of factors. Each industry, and each general work situation, poses it's own range of Fatigue Factors. However, in each instance, those Fatigue Factors can be identified, measured, and quantified in terms of the relative impact. A flexible set of limits can then be established, based upon evaluation of the entire body of Fatigue Factors which are present, allowing more or less work time and/or duty time, entirely predicated on a specific accumulation of Fatigue Factors within a given task or series of work tasks.

The Human Factors Scheduling Safety System is a business method, whether accomplished through manual or computer computation, which provides a process for limiting fatigue accumulations beyond levels which otherwise pose a safety hazard and/or adversely affect productivity. At the same time, the methodology allows for a greater range of scheduling flexibility, based on actual Fatigue Factor accumulations, rather than on the basis of an arbitrary work hours limitation. It is a methodology which is flexible, adaptable, and capable of application to virtually any situation in which fatigue might have an impact on resultant productivity and/or safety. Similarly, the process can be utilized as the basis for the payment of wages for actual work which is performed, rather than pay on the normal basis of work hours alone.

The current provisions of state wage laws, and collective bargaining agreements, exacerbate the number of situations in which an affected individual will accumulate fatigue. Most states allow individuals to work greater than eight (8) hours in a single work period, provided that they are paid “overtime” for the added work time. No regard is given to the time of day worked, or to the type of tasks which must be performed. Although shift differential pay might serve as an inducement for an individual to work a graveyard shift, on the “backside of the clock,” the additional wage does nothing to ameliorate the natural increase in fatigue which individuals working these hours will experience, as opposed to those individuals working a more normal “daylight” schedule.

The prior systems of scheduling personnel are, for the most part, based upon state law limitations. Fatigue is assumed to be purely a function of the number of hours worked. In the transportation industry, those limitations are set forth within regulatory provisions, such as the Federal Aviation Regulations (14 C.F.R. Part 121, Subparts Q, R, and S). Therein, the work limitations for aircraft pilots are provided in terms of the numbers of hours worked “in-flight” and “on duty.” However, even where two (2) possible factors are considered (flight hours and duty hours), there is no offset, or sliding scale, in which more of one element of the workday would allow more or less of the other element of a pilot's work day. Similar limits apply to truckers under the rules of the Federal Motor Carrier Safety Administration (49 C.F.R. Parts 385, 390, and 395).

The current system of personnel scheduling thus poses a number of significant disadvantages with respect to safety and productivity:
(a) Simple “work hours” limitations do not take into account the effects of the time of day involved, such as the traditional “graveyard” shift.
(b) The traditional “work hours” limitations do not account for the amount of work which must be accomplished during a particular work period, such as the number of required takeoffs and landings for a flight crew.
(c) “Work hours” limitations do not take into account the accumulated fatigue which might be experienced in multiple consecutive “work days,” which are separated by minimal intervening rest periods.
(d) Traditional “work hours” limitations do not take into account the fatigue exacerbation which might result from the intensity or length of an individual work assignment.
(e) “Work hours” limitations are not adaptable with respect to the exacerbating affects, such as poor nutrition, lack of meal opportunities, or inadequate opportunities for proper hydration.
(f) The traditional “work-hours” limitations arbitrarily create operating and economic disadvantages without a commensurate benefit for safety and/or productivity.

There are any number of job scheduling systems and business scheduling methods that have been formulated for the purposes of balancing workloads between resources. For example, in U.S. Pat. No. 4,852,001 to Tsushima et al (1989) and U.S. Pat. No. 4,744,028 to Karmarkar, the scheduling methodologies were formulated for the purposes of efficient resource allocation, rather than optimizing either safety or productivity. Scheduling descriptions therein took a view of the activities in terms of critical paths, strong branching, and even simultaneous generic algorithms, to achieve an efficiency. Neither of these examples address a flexible methodology by which limits to safety or human productivity might be measured.

More recently, additional work has been done to determine methods by which maximum levels of efficiency might be achieved. In U.S. Pat. No. 4,926,362 to Carns et al (1990) and, both U.S. Pat. Nos. 6,314,361 and 6,408,276 to Yu et al (2001) and (2002), resource utilization and use optimization were viewed alternately in terms of a maximum potential for a given scheduling scenario and in terms of rescheduling for optimum resource use in the event of an unscheduled intervening negative impact factor. In neither case, however, did the scheduling systems attempt to evaluate the degradation in efficiency which might be suffered through human fatigue accumulation during the course of schedule execution.

Of course, there are any number of unique patents which address scheduling and managing a given body of resources. In U.S. Pat. No. 4,037,743 to Rassman et al (1990), a system is described which dynamically manages and monitors resource scheduling and use. In U.S. Pat. Nos. 5,050,077 and 5,197,000, to Vincent (1991) and (1993), the described scheduling systems are specifically applied to a meeting scheduler which allows for alternatives and variables within the schedule. Likewise, in U.S. Pat. No. 5,260,868, to Gupta et al (1993), there is described a system for calendaring future events in real time. Then, in U.S. Pat. No. 5,270,930 to Pearse et al (1993), the resource allocation scheduling system is specifically applied to a training scheduler. However, even in U.S. Pat. No. 5,291,397 to Powell (1994), where the scheduling method directly addresses resource allocation and project control for production, there is no specific mention or use where either the ramifications of fatigue or fatigue amelioration are evaluated to provide for either optimization or risk management and assesment.

Though not on the target, a number of recent patents have evaluated the scheduling task in terms of resource constraints. In U.S. Pat. No. 5,406,476 to Deziel et at (1995), a system is devised by which scheduling is accomplished in terms of constraints to the available resources. In terms of what might be considered similar applications, in U.S. Pat. Nos. 5,623,413 and 5,794,172, to Matheson et al (1997) and (1998), scheduling contraints are evaluated in terms of plural objects proceeding through a multipath system. Under the right circumstances, this particular methodology might be adapted to the fatigue issue and for the purposes of evaluating the impact of fatigue with respect to safety or productivity. This would necessitate also adapting follow-on systems for the fatigue evaluation process, including possible adaptations of systems described in U.S. Pat. No. 6,035,277 to Anbil et at (2000), where multiple variables are approximated for optimal allocation of system resources. Likewise, a followup, or additional evaluation, might be necessary in an adaptation of U.S. Pat. No. 6,073,110 to Rhodes et al (2000), where there is described an activity based scheduling method. However, these patents do not target the fatigue issue.

In none of the above described patents, or other methods, has any-weight or consideration be given to the impact of accumulated fatigue within the schedule or scheduling system. Invariably, scheduling optimization is acheived through a general numeric evaluation, whether in terms of an algorithm or by a procedure defined approximation. Thus, in terms of either the safety or productivity degradation caused by accumulated fatigue within a defined schedule, the human factors evaluation and safety implications comprise an area which the prior art has systematically overlooked. This is especially true in terms of the safety impact of fatigue.

### INVENTION BACKGROUND—OBJECTIVES AND ADVANTAGES

Accordingly, the Human Factors Scheduling Safety System has been devised for the purpose of specifically addressing the impact of human fatigue in schedule evaluation, formulation, and execution. For each work situation and environment multiple factors, that negatively impact human alertness levels, are evaluated. The relative level of this impact is then calculated in terms of the available and evolving research, and numeric values are assigned to each Fatigue Factor according to its relative impact. Fatigue limits, or rules, are then established in terms Fatigue Factor accumulations as might affect safety and/or productivity. Finally, the quality and quantity of subsequent rest is evaluated in similar terms, in a determination of the amelioration of previously accumulated fatigue, and in terms of subsequent scheduled work periods. It is a scheduling system which evaluates multiple factors, relative impact, total fatigue accumulation, and intervening rest amelioration.

The advantages of this business method are:
(a) Actual levels of human fatigue accumulation can be monitored on an objective basis.
(b) Human fatigue accumulations may be limited to levels below which there will be a negative impact on safety and/or productivity.
(c) Fatigue evaluation can become a part of the schedule planning process.
(d) Work scheduling may be varied according to the actual levels of human fatigue which will be experienced, rather than on the basis of arbitrary work hours and/or duty hours.
(e) Variables such as “time of day on duty,” specific work tasks, prior rest, task intensity and frequency, as well as available nutrition and hydration opportunities during the work period, can be evaluated and planned to minimize induced fatigue.
(f) Intervening and subsequent rest may be planned to accomodate the needs of subsequent scheduled periods of work and/or duty, rather than at some arbitrary level which might otherwise not fully accomodate the real rest requirement for a specific task.

Further objectives and advantages of this scheduling system, and method, are to provide for a significant degree of scheduling flexibility. Work periods can be tailored to the precise demands of the task to be accomplished, and adjusted based on the variables which will be present, rather than on some otherwise arbitrary basis. This is especially helpful in the airline industry, where the demands of a particular flight crew work period can vary drastically, even when the work is accomplished in an otherwise identical duty period.

### SUMMARY

A personnel scheduling methodology which evaluates inherent Fatigue Factors, within a predefined set of computational parameters, as determined by research and/or observation, to ascertain cumulative, human factors limitations for any given period of scheduled work and/or duty. These limitations are computed on a sliding-scale, with consideration for the quality and quantity of rest immediately prior to a schedule period of work and/or duty, then providing for minimum intervening rest period for any subsequent period of scheduled work and/or duty.

### DRAWINGS—FIGURES

In the drawings, closely related figures have the same number but different alphabetic suffixes:

FIG. 1 shows a simplified schematic of the processes which comprise the Fatigue Factor computation methodology for the Human Factors Scheduling Safety System. Therein, reference is also made to the research, or observation, by which relative values and limits are established prior to undertaking the process.

FIG. 2 shows a simplified schematic of the process which comprises the Rest Factor amelioration computation method for the Human Factors Scheduling Safety System.

FIG. 3 shows a series of representations which constitute the function and flow of the Flight Crew Scheduling Safety System, the Sample Embodiment of the defined scheduling method.

FIG. 3A is the initial DATA ENTRY SCREEN, or data transfer parameters from other records systems, which provides the Scheduling Safety System with the raw data necessary for Fatigue Factor Accumulation computations. FIG. 3B is the data and functional flow for the Fatigue Factor Accumulation computations. FIG. 3C is the DATA ENTRY SCREEN, or data transfer parameters from other records systems, which provides the Scheduling Safety System with the raw data necessary for Rest Deduction computations. FIG. 3D is the data and functional flow for Rest Deduction computations.

FIG. 4 shows a listing of applicable algorithms and term definitions for the Flight Crew Scheduling Safety System, the Sample Embodiment of the defined scheduling method.

FIG. 5 shows a listing of preferred Flight Crew Scheduling Safety System values, the Sample Embodiment of the defined scheduling method. Although flexible and adaptable to a particular air carrier operating situation, these relative values can be widely utilized to assure a minimum relative level of flight crewmember fatigue, with consideration of the currently identified Fatigue Factors.

FIG. 6 is comprised of two figures, showing the algorithms and rules applicable to the Sample Embodiment for operation of the Flight Crew Scheduling Safety System. FIG. 6A shows a series of three (3) algorithms through which accumulated flight crewmember fatigue factors are calculated, and through which those fatigue factors are ultimately reduced by offsets for rest off duty. Those three (3) algorithms are: 1) the Fatigue Factor Accumulation Algorithm; 2) the Rest Reduction Algorithm, and; 3) the Prior Fatigue Factor Carryover Algorithm. FIG. 6B contains a series of algorithms which define the preferred limit rules for use with the Flight Crew Scheduling Safety System.

FIG. 7 shows a sample Fatigue Factor Computational Worksheet, through which the manual computation of accumulated fatigue factors, defined by the Sample Embodiment shown in the Flight Crew Scheduling Safety System, can be alternately accomplished in accordance with the basic scheduling system algorithms.

FIG. 8 shows a sample Rest Factors Computational Worksheet, defined by the Sample Embodiment, through which the manual computation of overall rest factors, used to assure adequate crewmember rest and safety within the Flight Crew Scheduling Safety System, can be alternately accomplished in accordance with the basic scheduling system algorithms.

### ALSO ATTACHED FOR THE SAMPLE EMBODIMENT

APPENDIX 1—Instructions for manual completion of the sample Fatigue Factors Computational Worksheet, as associated with the Sample Embodiment.

APPENDIX 2—Instructions for manual completion of the sample Rest Factors Computational Worksheet, as associated with the Sample Embodiment.

APPENDIX 3—Instructions and Description for the Flight, Duty, and Rest Limitation Rule algorithms, as associated with the Sample Embodiment.

### DETAILED DESCRIPTION—METHOD CONCEPT

The Human Factors Scheduling Safety System is a business method by which Fatigue Factor values, for a particular work task or work duty period, are summed and compared against an established limit value. Each element, or Fatigue Factor, can be accumulated on a sliding-scale in relationship to all other identified Fatigue Factors, until an established limit is reached. Thereafter, rest must be taken, of a quality and duration, which will ameliorate the previously accumulated Fatigue Factors to the point that the subsequent work tasks, or work duty period, may be accomplished safely and/or efficiently. Where intervening rest does not completely ameliorate accumulated Fatigue Factors, subsequent work tasks or duties must be limited in accordance with the established values and/or rules.

The Human Factors Scheduling Safety System requires that, prior to use of the system, research be undertaken to determine the Fatigue Factors which are present for a particular duty period or work task. The identification of these Fatigue Factors is a part of the “pre-process” evaluation. In addition, prior to use of the system, the relative impact of each Fatigue Factor must be established and quantified. Once the associated Fatigue Factors are quantified, establishing a relative level of impact, and the rules for limitation of the Fatigue Factors has been established, the personnel scheduling processes of the Human Factors Scheduling Safety System begin.

A. The Pre-Process—

1. Prior to undertaking the process defined for the Human Factors Scheduling Safety System, there is first established a list of the factors which affect individual alertness levels (“Fatigue Factors”) within a particular job task, or set of job tasks, or for a particular work duty assignment.

2. After the Fatigue Factors are identified, research and evaluation establishes the relative impact of each Fatigue Factor, versus each of the other Fatigue Factors, which might be present for a particular work task or duty assignment. In this way, a Fatigue Factor Value System is set.

3. Once a Fatigue Factor Value System has been established, a Limiting Fatigue Factor Rule, or rules, is set.

4. An additional evaluation is undertaken to determine the duration and quality of subsequent rest (“Rest Factors”) which is necessary to fully, or partially, ameliorate accumulated Fatigue Factors under the Limiting Fatigue Factor Rules.

B. The Scheduling Safety System Process—

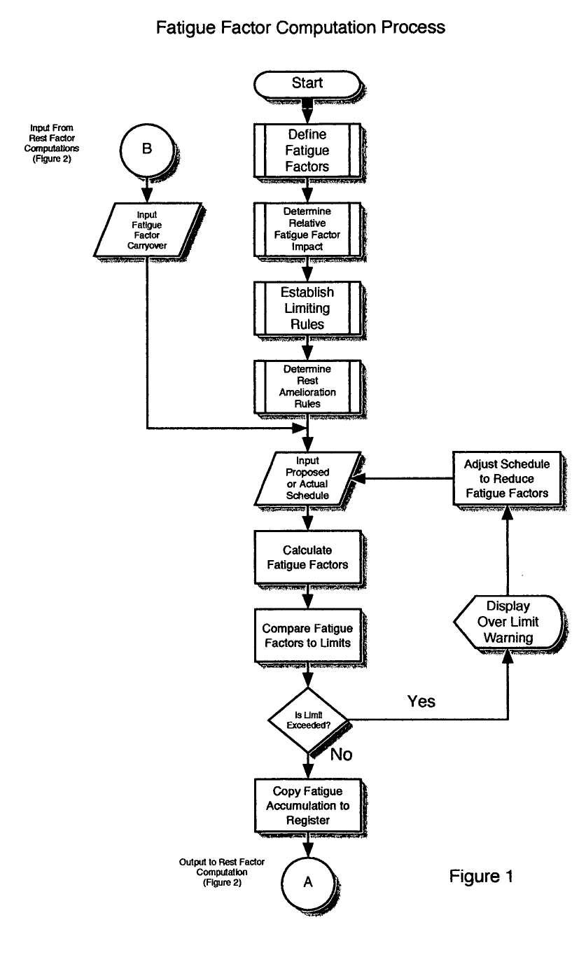

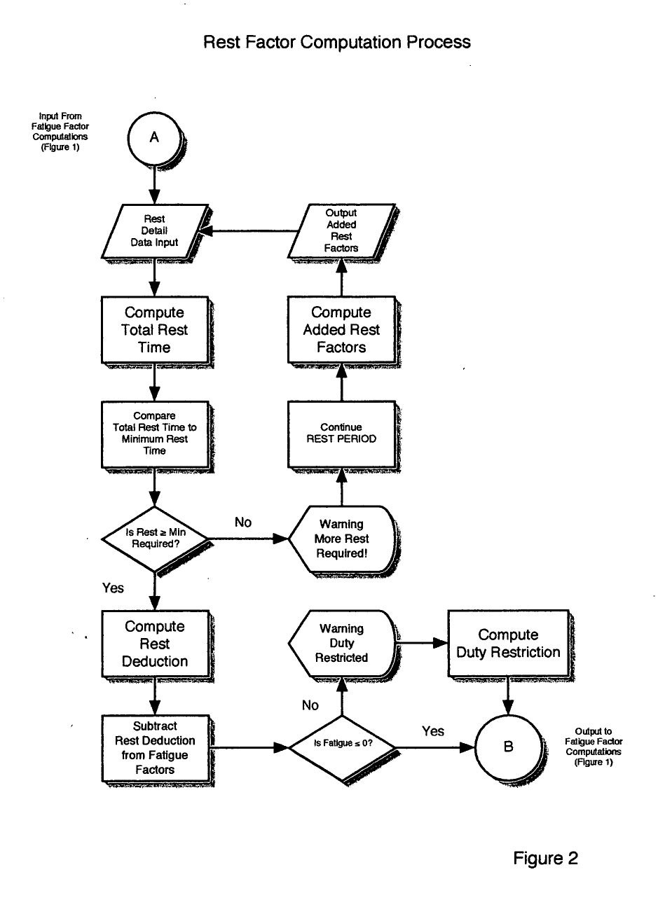

The business method which comprises the Human Factors Scheduling Safety System has applications in two main areas. First, it is a method that is used in the “schedule planning” process. Second, it is a method that is used in the schedule execution process, where unplanned variables are also accounted for in the determination of both the rest requirements necessary for a rest period subsequent to a work task or duty period, and in the determination of the suitability for an individual to undertake additional subsequent work tasks or duty assignments. The method for calculating accumulated Fatigue Factors is set forth within FIG. 1. The subsequent flow for calculating the subsequent Rest Factors is set forth within FIG. 2.

1. Create an individual work or task schedule.

2. Enumerate the pre-defined Fatigue Factors which are present in the individual work task or duty assignment.

3. Sum the numeric value of the cumulative Fatigue Factors present in the individual work task or duty assignment.

4. Compare the sum of the cumulative Fatigue Factors to the predetermined limit values.

5. Determine whether or not the predetermined limits are exceeded.

6. For schedule planning purposes, a valid schedule is one in which the accumulated Fatigue Factors do not exceed the predetermined limit values.

7. For the schedule planning and execution purposes, the numeric value of the accumulated Fatigue Factors are then evaluated in terms of the Rest Factors necessary to ameliorate accumulated fatigue in order to allow a subsequent period of work or duty.

8. Calculate required rest based on the predetermined rest amelioration computation.

9. Determine whether or not intervening rest will be of a sufficient numeric value to allow for a subsequent planned period of work or duty.

10. Maintain a record of the accumulated Fatigue Factors, and Rest Factor amelioration values, on an ongoing basis.

### DETAILED DESCRIPTION—SAMPLE EMBODIMENT

The Sample Embodiment of the Human Factors Scheduling Safety System has been set forth for use in the airline industry. That Sample Embodiment is herein referred to as the Flight Crew Scheduling Safety System. The specific application is adapted for use in scheduling and tracking airline pilots.

Accepted research proves that, beyond the normal flight hours limitations, flight crewmember fatigue is greatly affected by the number of operating cycles (takeoffs and landings), time on duty, time of day on duty, time zone changes, rest, and even nutritional and hydration factors. Each of the recognized Fatigue Factors can be accommodated in a system which addresses varying mixes and levels of Fatigue Factors, beyond the normal requirement to limit flight hours and provide minimum periods of rest. These factors are implemented in line with the general specification as set forth above.

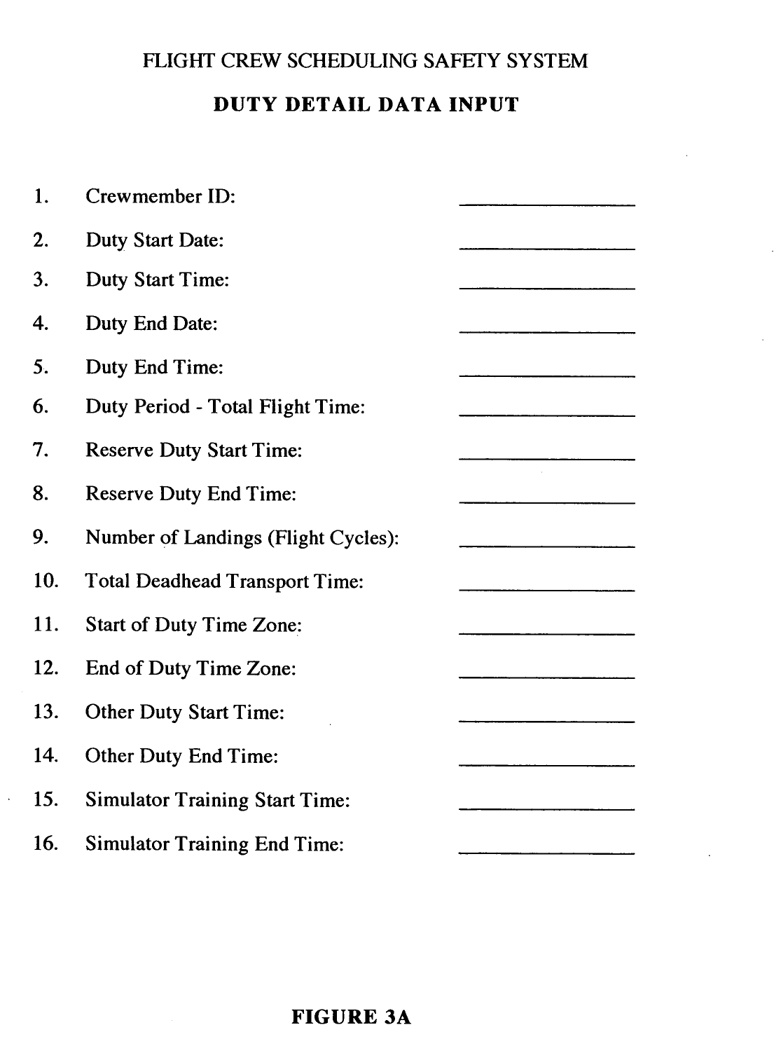

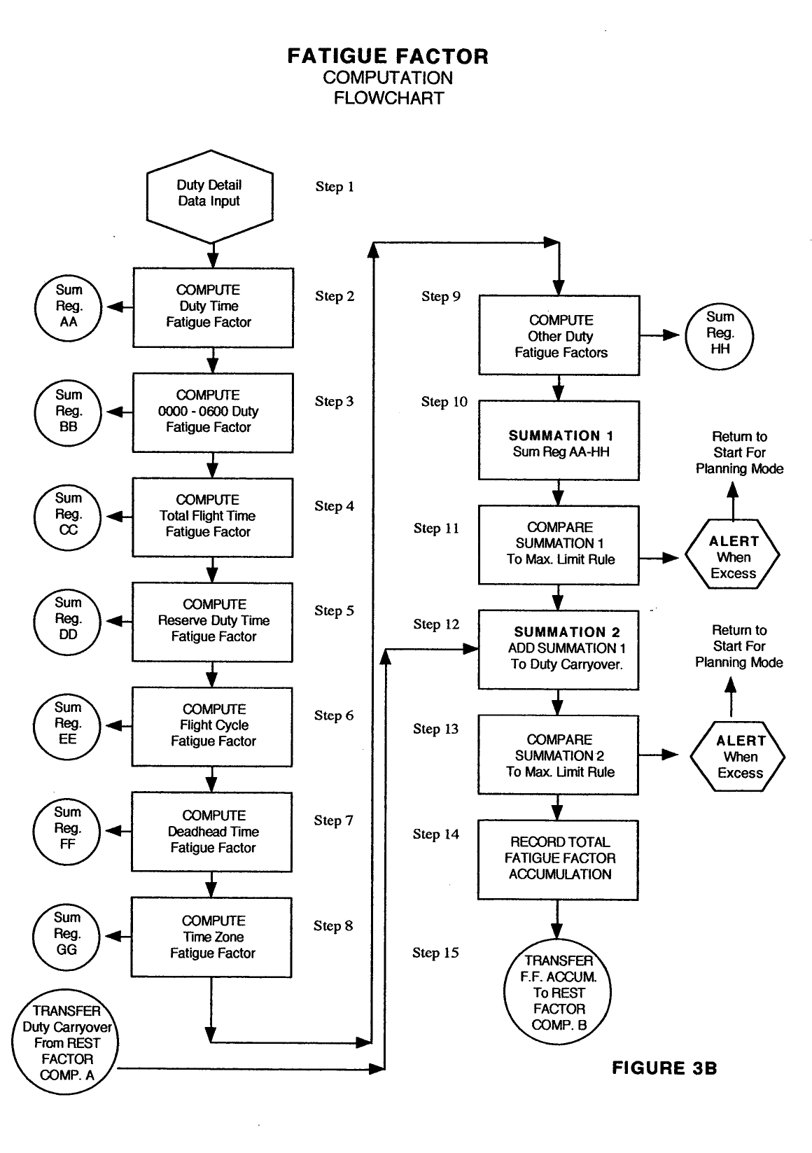

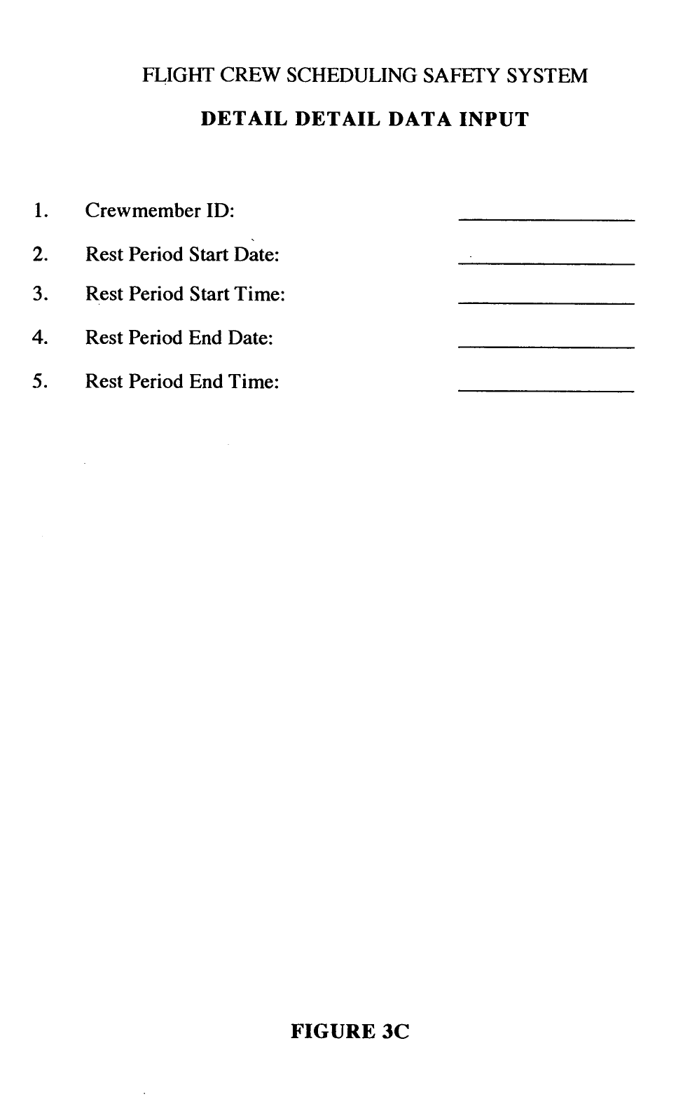

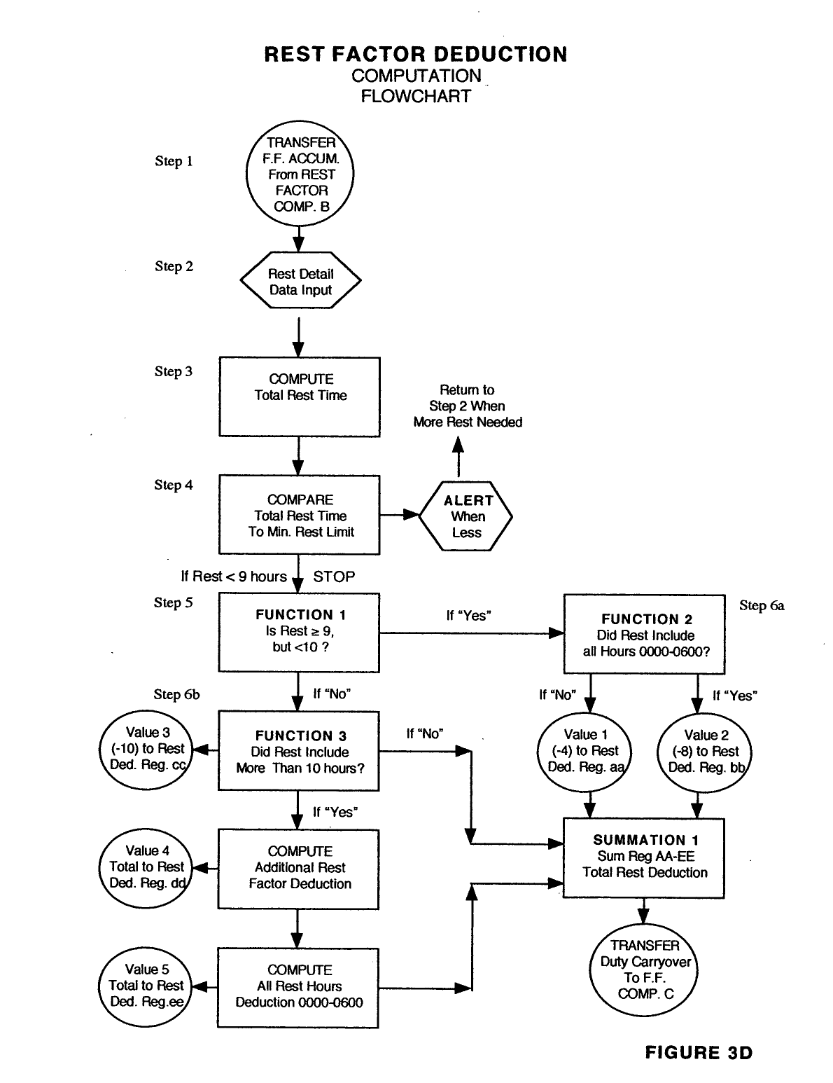

The Sample Embodiment set forth for the Flight Crew Scheduling Safety System follows a simple flow of operation (FIG. 3), whether it is part of the schedule planning process or whether it is used to track actual flight crewmember on-duty operations. Again, it is assumed that the Fatigue Factors, in terms of relative value, have been established for the evaluation at hand. It is further assumed that maximum Fatigue Factor accumulation limits have been determined, as well as the necessary level of rest to return an individual to a subsequent period of work or duty after the rest.

After data entry or transfer, of the actual or proposed work schedule and associated Fatigue Factors, the process first requires computation of the Fatigue Factors (points) which a flight crewmember accumulates during a given period of air carrier duty. Then, based upon a set minimum hours requirement, there is a mathematical evaluation of whether any intervening period, between two periods of carrier duty, qualifies as rest. Finally, where intervening rest has occurred, Rest Factors (points) are tallied and subtracted from the individual crewmember's accumulated Fatigue Factors (points).

Before a flight crewmember is allowed to return for subsequent carrier duty, there is a mathematical evaluation of whether a flight crewmember's intervening rest was sufficient to qualify him/her to return to work for a particular subsequent type of duty or flight operation. This determination is made based upon a set rule, or maximum value, as determined by the Scheduling Safety System. This determination may be based upon those preferred values set forth here, or those established by virtue of a regulatory approval, a labor contract, or any combination of the above.

A. Fatigue Factors Computation (Worksheet):

The Initial DATA must be obtained and/or entered for evaluation.

Step 1

After the initial DATA ENTRY (FIG. 3A; Step 1) the first Fatigue Factor evaluated is the TOTAL TIME ON DUTY during a given duty period. The references made here are for actual times, where the Scheduling Safety System is being used for records-keeping purposes, or for planned times where the System is being used for planning and evaluation purposes.

Step 2

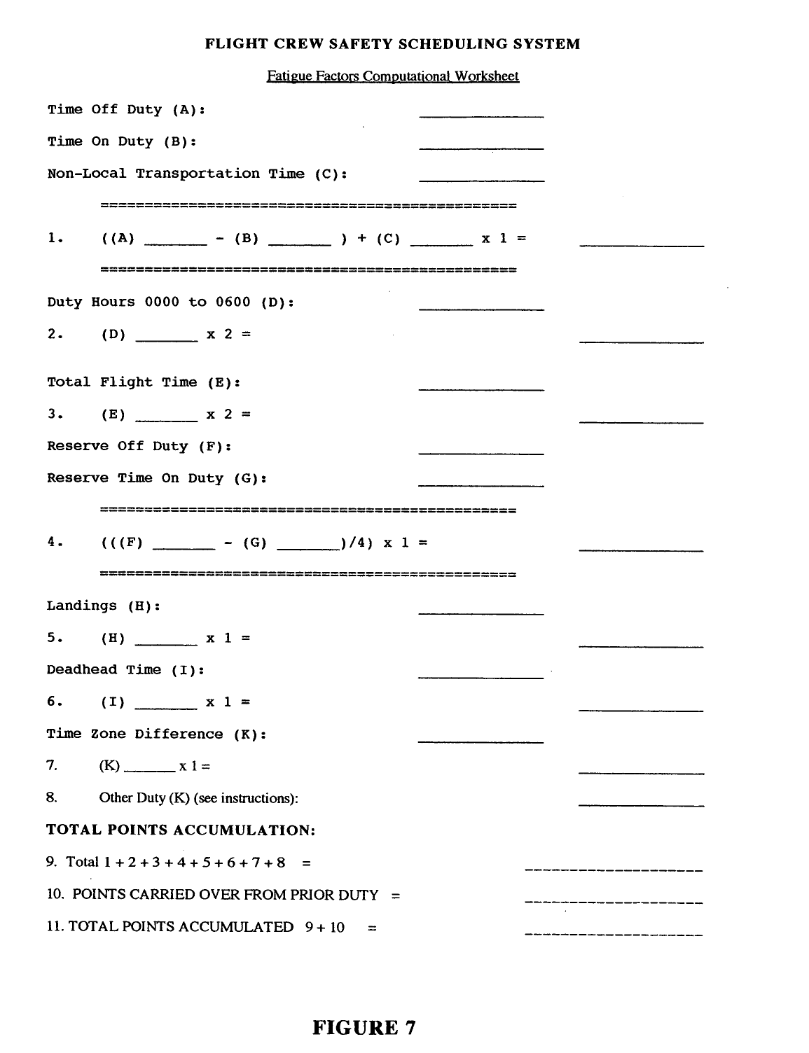

Referring to the Fatigue Factor Computational Worksheet (FIG. 7), an entry is made for the actual or planned “Time Off Duty.” A second entry is made for the planned or actual “Time On Duty.” (In the airline industry the “Time On Duty” and “Time Off Duty” is most often determined based upon the requirements of applicable labor agreements as predicated on flight “block out” and “block in” times.) The times used herein reflect preferred additives to the planned or actual “block out” and “block in” times to include preflight planning and post flight record keeping duties. (A description of the preferred on duty additives is provided within the Fatigue Factors Computational Worksheet Instructions—Appendix 1).

In accordance with the Fatigue Factors Computational Worksheet Instructions (Appendix 1), in any situation in which a flight crewmember requires transportation to/from a distant location, such as a distant hotel for crewmember rest, an additional time value is required to be added to the Total Time On Duty. The user then subtracts the “Time On Duty” from the “Time Off Duty,” and adds any required additional time value for “Non-Local Transportation Time.” The result is the “Total Time On Duty.” Under this Sample Embodiment, partial hours are rounded up to the next full hour. The Total Time On Duty is then multiplied by the preferred On Duty Fatigue Factor index value (1), as set forth within FIG. 7. The result is entered on the adjacent line (Line 1) within the Fatigue Factors Worksheet for subsequent summation with the other computed Fatigue Factor values (FIG. 7). For a computer system, the sum tallies to a Sum Register (Sum Reg. AA; FIG. 3B).

Step 3

The second of the Fatigue Factor considered is that additional fatigue involved in flight crew duty on the “backside of the clock,” a common occurrence in the transportation industry. Although a great deal of precision is possible with respect to the exact hours and measurement of the degree of fatigue involved in operations at specific hours of the night, the preferred methodology is one in which an individual flight crewmember is readily capable of manually generating the required computations. Thus, in this sample, partial hours are round up to the next full hour. (Under a more precise, computer based variation, fractional values and additives can be utilized during the hours where research proves that additional or fewer Fatigue Factors are experienced). Therefore, all of the hours between 0001 hours and 0600 hours are treated with the same value consideration under the Sample Embodiment. According to the Sample Embodiment, where a flight crewmember undertakes any duty between the specified hours, as determined at the station where the crewmember first reported for that duty period, each such hour or fraction thereof constitutes an added Fatigue Factor.

The number of hours served by a flight crewmember, between 0001 hours and 0600 hours, is entered as a whole, positive number. As before in this sample, all fractional hour values are rounded up to the next whole hour. That number is then multiplied by the established Fatigue Factor index value (2) on Computation Line 2 (FIG. 7). The result is entered on the adjacent line within the Fatigue Factors Worksheet for subsequent summation with the other computed Fatigue Factor values. For a computer system, the sum tallies to a Sum Register (Sum Reg. BB; FIG. 3B).

Step 4

The third Fatigue Factor which the Scheduling Safety System considers is that of the actual flight time which a flight crewmember accumulates. Although more precision might be obtained using actual hours and minutes involved in flight operations, in the Sample Embodiment, all fractional hours of flight time, accumulated during a given period of flight crewmember duty, are rounded up to the next whole hour. An entry is made for this flight time on the Fatigue Factors Worksheet. The flight hours are then multiplied by the preferred Fatigue Factor index (2) on Computation Line 3 (FIG. 7). The result is entered on the adjacent line within the Fatigue Factors Worksheet for subsequent summation with the other computed Fatigue Factor values. For a computer system, the sum tallies to a Sum Register (Sum Reg. CC; FIG. 3B).

Step 5

Consideration of a fourth Fatigue Factor is necessary due to the common practice in the transportation industry, that is, placing crewmembers on a standby or reserve status for callout to a regular duty assignment. Where this “callout” for duty might occur at any time, with the actual carrier duty commencing at any subsequent time, this Reserve Duty period involves a Fatigue Factor which must be considered. Therefore, an entry is made on the Scheduling Safety Worksheet for the Reserve Duty Off time and the Reserve Duty On time. For all practical purposes, a Reserve Duty Period ends at the time a crewmember is “called out” for duty. However, in this Sample Embodiment where the intervening period, between the “callout” and the actual duty, is less than nine (9) hours, under the preferred methodology, all of the intervening time is considered as a continuation of the Reserve Duty Period until actual duty commences.

The Reserve Time On Duty is subtracted from the Reserve Duty Off time to compute the Total Reserve Duty Time. This Total Time, in hours and fractions of hours, is then rounded up to the next whole hour, as established for the Sample Embodiment. This whole number result is then divided by 4 (meaning that Reserve Duty involves one quarter of the Fatigue Factor as actual time on duty). Again, under the Sample Embodiment, the result is rounded up to the next whole number and multiplied by the Reserve Duty Fatigue Factor index value (1). The result is entered on the adjacent line (FIG. 7; Line 4), within the Fatigue Factors Worksheet, for subsequent summation with the other computed Fatigue Factor values. For a computer system, the sum tallies to a Sum Register (Sum Reg. DD; FIG. 3B).

Step 6

It has been long recognized that the number of flight cycles (takeoffs and landings) required of a flight crewmember impose a significant additional Fatigue Factor. Although, in a computer based real-time system, much more precise values might be possible as a measure of fatigue during night time or in poor weather conditions, under the preferred method set forth here, all flight cycles are treated as involving the same Fatigue Factors. For the duty period under review or evaluation, an entry is made for the number of Total Landings which a flight crew completes as is planned. That number is then multiplied by the preferred Fatigue Factor index value (1). The result is entered on the adjacent line (FIG. 7; Line 5), within the Fatigue Factors Worksheet, for subsequent summation with the other computed Fatigue Factor values. For a computer system, the sum tallies to a Sum Register (Sum Reg. EE; FIG. 3B).

Step 7

Flight crewmembers are also often involved in deadhead transportation as a part of a given period of carrier duty. Where a flight crewmember is transported to a distant location as a part of his/her duty period, other than the non-local transportation which might be involved in reaching provided rest facilities, that Deadhead Transportation Time constitutes an additional Fatigue Factor which is evaluated in the Scheduling Safety System. An entry is made for all time which a flight crewmember spends in deadhead transportation. Where the time includes any fraction of an hour, under the Sample Embodiment, that fraction of an hour is rounded up to the next whole hour. The total number of whole hours spent in deadhead transportation is then multiplied by the Sample Embodiment's Fatigue Factor index value (1). The result is entered on the adjacent line (FIG. 7; Line 6) within the Fatigue Factors Worksheet for subsequent summation with the other computed Fatigue Factor values. For a computer system, the sum tallies to a Sum Register (Sum Reg. FF; FIG. 3B).

Step 8

Research defines an additional Fatigue Factor involved in flight crewmember movement through time zones. The degree to which an individual's circadian rhythms are disrupted depends, in a large degree, on the individual involved and the other factors related to actual type of travel and duty involved. However, under the Sample Embodiment, where a flight crewmember begins his duty day in one time zone, and finishes that duty day in another time zone, a Fatigue Factor computation is required. Under the Sample Embodiment, no such computation is necessary where a flight crewmember begins and ends his/her duty period within the same time zone.

Although there are many possible variations as to how the actual time zone difference might be computed for this sample, the Total Time Zone Difference is entered on the Scheduling Safety System Worksheet. This is an absolute positive value. That whole number is then multiplied times the preferred Fatigue Factor index value (1), for time zone travel. The result is entered on the adjacent line (FIG. 7; Line 7) within the Fatigue Factors Worksheet for subsequent summation with the other computed Fatigue Factor values. For a computer system, the sum tallies to a Sum Register (Sum Reg. GG; FIG. 3B).

Step 9

Other carrier duty constitutes an additional Fatigue Factor which the Scheduling Safety System evaluates. For example, crewmembers might be required to attend a carrier meeting or ground training session as a part of his/her continuous duty day. In addition, some flight crewmembers are involved in management or supervisory duties just prior to or at the end of a given duty day. All such time is treated as duty on an hour for hour basis.

Under the Sample Embodiment, where there is not an intervening rest period of at least nine (9) hours, the time on duty is considered continuous with the subsequent period of flight or other duty. Again, partial hours are rounded up to the next whole hour. For purposes of this evaluation, all time spent in other carrier duty is entered, in whole hours, and multiplied times the preferred Fatigue Factor index value (1). The result is entered on the adjacent line (FIG. 7; Line 8) within the Fatigue Factors Worksheet for subsequent summation with the other computed Fatigue Factor values. For a computer system, the sum tallies to a Sum Register (Sum Reg. HH; FIG. 3B).

Under the Sample Scheduling System methodology, the only other carrier duty which is treated differently, from that just described, is carrier duty which is spent in simulator Training. For the purposes of Fatigue Factor evaluation, all time spent in simulator training, including the time spent in briefing and debriefing, is multiplied by the preferred Fatigue Factor index (2). This Fatigue Factor applies whether a flight crewmember functions as a student, as an instructor, or company check airman.

Step 10

Although a number of other Fatigue Factors may be computed and evaluated in a more precise computer based Scheduling Safety System, or additional values computed based upon regulatory or contractual requirements, the remaining computations on the Fatigue Factors Computational Worksheet simply involve summations. The Total Fatigue Factors accumulated during a given period of duty is computed as the sum of Fatigue Factors Worksheet (FIG. 7) Lines 1 through 8. (In a computer based system, the tally for Sum Registers AA through HH are added to obtain the Total Fatigue Factor Accumulation). This can be accomplished by the following algorithm, or some variation:
L₁+L₂+L₃+L₄+L₅+L₆+L₇+L₈=Total Fatigue Factors
or
Line 1+ . . . +Line 8=Total Fatigue Factors

Step 11

The above sum of Total Fatigue Factors (Step 10) is used for a number of comparisons. First, for planning purposes and in accordance with the Sample Embodiment, a determination can be made as whether the planned flight sequences exceeds any maximum limit. This determination could result in either a change in the sequence or a change in the composition of the flight crew in order for the planned flight sequence to fall into another limit category. Second, for actual record tracking purposes, any operation which exceeded the preferred maximum limit values will trigger an additional rest requirement prior to the return of a flight crewmember to carrier duty. The sum, however, is retained for additional computations (FIG. 7; Line 9).

Step 12

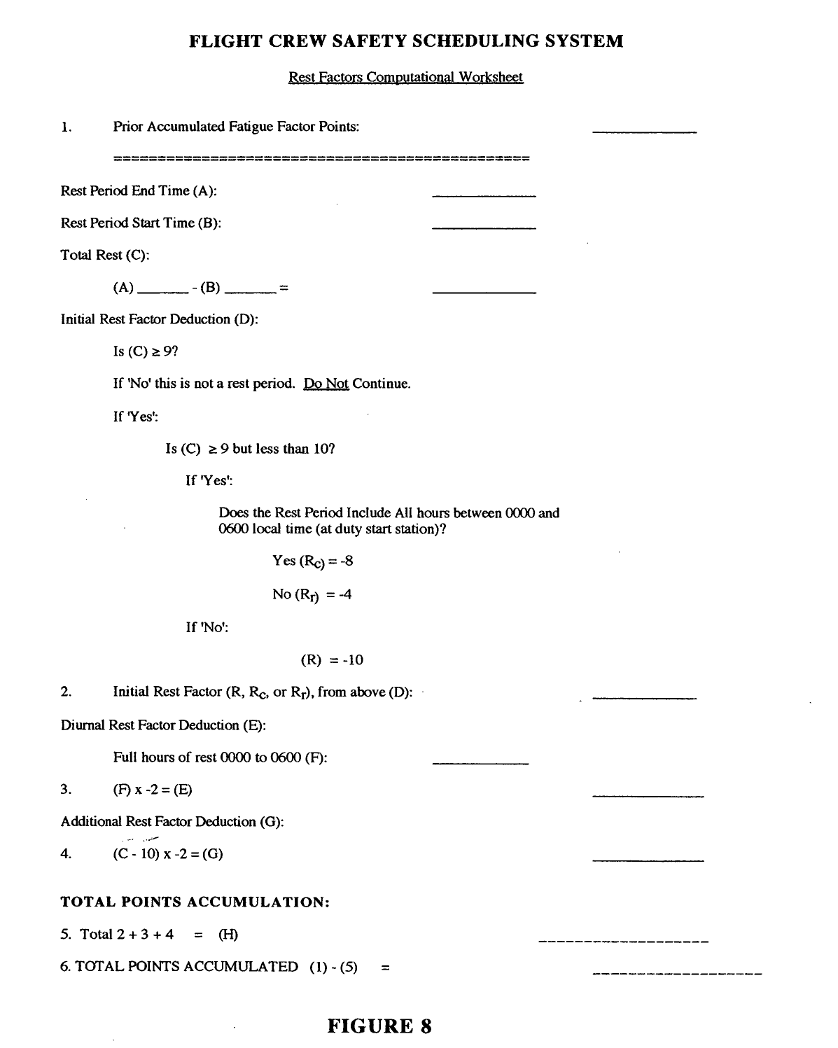

The Points Carried Over From Prior Duty (FIG. 7; Line 10) is a value which is wholly dependent upon the rest obtained prior to the present duty under evaluation. In accordance with the methodology for computing the Rest Factors Worksheet (FIG. 8), intervening Rest Factor values, between any prior duty and the currently considered duty period, were subtracted from the prior accumulated Fatigue Factors. Any remainder, that is Fatigue Factors which were not completely negated by intervening rest, are carried over to the current duty period and entered on this line (FIG. 7; Line 10) for summation. (For a computer based system, a database transfer is made of the “Carryover” from the computations for the most recent rest period).

Step 13

Under the Sample Embodiment, this Points Carrier Over From Prior Duty is used to determine whether a flight crewmember may undertake the planned or additional duty. (For example, under the Sample Embodiment, no duty may be undertaken for “backside of the clock” operations unless the prior Fatigue Factor accumulation has been reduced to zero. Front side of the clock duty may be undertaken with an accumulation of as many as twenty (20) Fatigue Factor points). The points entered here are compared with the Sample Embodiment's maximum values limits.

Step 14

The final Scheduling Safety System Worksheet (FIG. 7) computation is a sum of the Points Accumulated during the present duty period and the Points Carried Over From Prior Duty. Line 9 is added to Line 10. The result is entered on the adjacent line (FIG. 7; Line 11).

This result (Line 11) is then used as the basis to determine the amount of rest, as required by the Rest Factors Computational Worksheet or computer algorithms, which a flight crewmember will need prior to the time he/she is allowed to return for additional carrier duty. The time and the type of duty which a flight crewmember will be allowed to accomplish upon return to duty, is determined from the value rules established for a particular carrier in a manner consistent with this Sample Embodiment. These values rules will be based upon regulatory requirements, the preferred values methodology established for the carrier, existing labor agreements, or a combination of all of these factors.

B. Fatigue Factors Computation (Computer):

The process by which a computer system will apply and calculate the Flight Crew Scheduling Safety System is nearly identical to that which was described above for the above described manual Sample Embodiment. A computer version of the Scheduling Safety System can be constructed as a standalone application, as a series of subroutines in an existing computer scheduling optimization program, elements within an existing spreadsheet type program, or even based upon an existing database program. As described here, the Scheduling Safety System is provided as a standalone program which is readily adaptable to any of the other possible alternative implementations.

A computer system has the obvious additional advantages of allowing the Scheduling Safety System to achieve a much greater degree of precision, using hours, minutes, and even seconds. However, this increased precision is achieved at the cost of the ease with which manual computations might be completed by individual crewmembers for their personal tracking purposes, or in the event of a computer system malfunction where data must be manually generated and evaluated. The description here is for the preferred system configuration of the Sample Embodiment, which includes rounding fractional hours to whole hour values, with the rounding done to the safer or more conservative value.

The computation of the Fatigue Factors accumulation on a computer system is significantly easier than through the manual means, as was previously described. In the manual system, a close examination of the results is required in order to determine that maximum allowed values are not exceeded. However, these limits, and warnings, can be readily accomplished within a computer based system through adaptation of the existing software systems which are set to react to predetermined trigger value limits.

Step 1

A standalone program simply requires either appropriate data-entry pages (FIGS. 3A and 3C), or a data porting subroutine to obtain the required information. This information may also be obtained and converted from any existing flight crew optimization and/or records-keeping program. (Any such subroutines, for porting purposes, is separate from the Scheduling Safety System). In the least desirable alternative, the Scheduling Safety System can be adapted to an existing database program, where that existing database program can be utilized to maintain flight crewmember records generated by means of the Scheduling Safety System.

Referring to the program flowchart (FIG. 3B), the data entries made for the Time Off Duty and Time On Duty (FIG. 3A) are obtained from a crewmember's record register. In the planning process, these times are simply entered for further, independent evaluation of proposed flight schedule pairings. (A separate optimization computer program can be used to determine optimized flight pairing values based upon other, externally supplied limits). The Scheduling Safety System then completes a subtraction computation (Time Off Duty)−(Time On Duty) to determine the Total Duty Time for a particular crewmember duty period.

Step 2

Again, using the Sample Embodiment, any fractional result is rounded to the next higher whole number for further computations based upon the computed Hours On Duty. Then, using the preferred value for the “Hours On Duty Fatigue Factor” index (1 point), the Hours On Duty is multiplied by the Fatigue Factor index (Hours On Duty)x1 to obtain the accumulated Fatigue Factor value. The resultant value for the “Hours On Duty Fatigue Factor” is then stored in the “Accumulated Fatigue Factors Register” for later summation with the subsequently determined Fatigue Factors.

This computation can be expressed by algorithm in two ways:
Hours On Duty Fatigue Factor=((d₁+ . . . +dₓ)+nt)×1, 1.
or
(((Time Off Duty)−(Time On Duty))+Transport Time)×1 2.

Each of the subsequent Fatigue Factor elements is computed in a fashion similar to that previously described for the manual Fatigue Factor Worksheet methodology. Depending on the optimum process for existing computer systems, results for each Fatigue Factor computation can either be ported to a summation register for subsequent computations, or those individual results may be saved as either a database entry or a spreadsheet type cell value.

Step 3

The computer based system then continues on with the Fatigue Factor accumulation calculations, determining the Fatigue Factor value for duty hours occurring between 0000 hours through 0600 hours. Again, under this sample, this is based upon the local time at the airport where a flight crewmember first reports for the duty period under evaluation. And again, the manner in which this local time is calculated and entered may be accomplished by a variety of methods, including based upon Universal Coordinated Time (UTC), with adjustment for the time zone variations between the duty report station and the station at which subsequent rest is begun by a flight crewmember. In any event, the Total of the Duty Hours between 0000 hours and 0600 hours, rounded to the next higher whole number when there is a fractional result, is multiplied by the applicable Fatigue Factor index. In this instance, the preferred system index value is two (2).

The resultant algorithm would read as follows:
(b₁+ . . . +bₓ)×2=0000 to 0600 Fatigue Factor.

The resultant value for the “Duty Hours 0000 to 0600” is then stored in the “Accumulated Fatigue Factors Register” for later summation with the subsequently determined Fatigue Factors.

Step 4

The computer based system continues its computations and summation routines. The Total Flight Time Fatigue Factor is generated by calculating the Total Flight Hours flown by a flight crewmember, and multiplying that result by the preferred Fatigue Factor index value (2). Again, under the Sample Embodiment, any fractional hour value is rounded to the next higher whole hour.

The resultant algorithm would read as follows:
(f₁+ . . . +fₓ)×2=Flight Hours Fatigue Factor.

The resultant value for the “Flight Hours Fatigue Factor” is then stored in the “Accumulated Fatigue Factors Register” for later summation with the subsequently determined Fatigue Factors.

Step 5

As with the previously described manual Fatigue Factors Worksheet, any time which a flight crewmember spends on Reserve or Standby Duty constitutes an additional fatigue factor. Under the Sample Embodiment, the Total Time On Reserve Duty is calculated by a subtraction routine. (Reserve Time Off Duty)−(Reserve Time On Duty)=Total Time On Reserve Duty. However, where any such Reserve period has an intervening time period of less than nine (9) hours between the end of the Reserve Duty Period, and any subsequent period of carrier flight or other duty, any intervening time period is considered to be continuous Reserve Duty for purposes of the Reserve Duty Time Computation.

The Total Reserve Duty Time result is then divided by the preferred Fatigue index value (4).

This computation can be expressed by algorithm in two ways:
Reserve Duty Fatigue Factor=(c₁+ . . . +cₓ)/4, 1.
or
((Reserve Time Off Duty)−(Reserve Time On Duty))/4 2.

The resultant value for the “Total Reserve Duty Time” is then stored in the “Accumulated Fatigue Factors Register” for later summation with the subsequently determined Fatigue Factors.

Step 6

The computer based system then continues its computations and summation routines. The Flight Cycle (landings) Fatigue Factor is generated by calculating the Total Landings which a flight crewmember participated in as the part of a flight crew. That Total Landings result is then multiplied by the preferred Fatigue Factor index value (2).

The resultant algorithm would read as follows:
(w₁+ . . . +wₓ)×1=Flight Cycles Fatigue Factor.

The resultant value for the “Flight Cycles Fatigue Factor” is then stored in the “Accumulated Fatigue Factors Register” for later summation with the subsequently determined Fatigue Factors.

Step 7

The computer system then continues. The Deadhead Fatigue Factor is generated by calculating Total Time which a flight crewmember spends in deadhead transportation. This is a calculation which is in addition to the Total Time On Duty which was previously calculated. Where the result contains any fractional value, under the preferred system implementation, that fractional value is then rounded up to the next higher whole number (integer). That Total Deadhead Time result is then multiplied by the preferred Fatigue Factor index value (1).

The resultant algorithm would read as follows:
(t₁+ . . . +tₓ)×1=Deadhead Fatigue Factor.

The resultant value for the “Deadhead Fatigue Factor” is then stored in the “Accumulated Fatigue Factors Register” for later summation with the subsequently determined Fatigue Factors.

Step 8

The computer based system then continues with its computation for the Time Zone Difference Fatigue Factor. As in the manual Fatigue Factor Worksheet, this factor is based upon the time zone differences between the station where a flight crewmember first reported for duty, and the station where the flight crewmember is released for subsequent rest. If there is no time zone difference, no computation for this value is required. Again, the basic time zone difference can be calculated in any number of ways, including manually, from an existing scheduling optimization system database, or ported from any other system of crewmember records maintenance. In any event, the Total Hours Difference between the time zones, a positive whole integer, is multiplied by the preferred Fatigue Value (1). The resultant value for the “Time Zones Fatigue Factor” is then stored in the “Accumulated Fatigue Factors Register” for later summation with the subsequently determined Fatigue Factors.

Step 9

Although any number of additional Fatigue Factor variables might be generated and evaluated by the Scheduling Safety System, the last of the Fatigue Factors considered within the Sample Embodiment are the Fatigue Factors for “Other Duty” performed by the flight crewmember. This includes, but is not limited to, company ground training, management duties, supervisory responsibilities, mandatory testing, and times spent in counseling or company required briefings.

As with the manual Fatigue Factors Worksheet, all such time is treated as duty on an hour for hour basis. And, under the preferred methodology, where there is not an intervening rest period of at least nine (9) hours between the other duty and scheduled flight duty, the time on duty for these other activities is considered continuous. Again, partial hours are rounded up to the next whole hour. For purposes of this evaluation, all time spent in other carrier duty is considered in whole hours, and multiplied times the preferred Fatigue Factor index value (1). Under the preferred value system, the only “Other Company Duty” which is considered differently is simulator training. The Fatigue Factor index value for simulator training is two (2). The resultant value for the “Time Zones Fatigue Factor” is then stored in the “Accumulated Fatigue Factors Register” for later summation.

Steps 10-15

The computer based Scheduling Safety System then accomplishes a summation of all of the Fatigue Factor values which have been entered into the summation register. This result is the Total Fatigue Factors for the planned or actual company duty which have been evaluated. For planning purposes, this value is compared, either manually or by computer subroutine, with the maximum limit rules which are established for a particular type of flight operation with a particular type of flight crew. For example, under the Sample Embodiment, a two-man crew operating an aircraft which is certificated to require a two-man crew would be limited to a Total Fatigue Factor Accumulation of no more than forty (40) points under the preferred system rules. A three-man crew on an aircraft certificated for a two-man crew would alternatively be limited to a Total Fatigue Factor Accumulation of not more than fifty (50) points.

As with the manual Fatigue Factors Worksheet, the computer based system does not work in isolation. The Total Fatigue Factor Accumulation also considers a flight crewmember's carrier duty, prior to the current period under evaluation, where that prior carrier duty was not fully negated by an adequate period of intervening rest. Therefore, a computation of Rest Reduction Factors, during the prior period of rest, is deducted from the prior Total Fatigue Factor Accumulation to determine any necessary Fatigue Factor Carryover. This Carryover number is then added to the Total Fatigue Factors determined for the current period of carrier duty for a Total Fatigue Factor Accumulation.

The algorithm for this process may be expressed as follows:

$$P = {P}_{p} - D + ( {f}_{1} + … + {f}_{x} ) + ( {d}_{1} + … + {d}_{x} ) + ( {w}_{1} + … + {w}_{x} ) + \\ ( {b}_{1} + … + {b}_{x} ) + ( {c}_{1} + … + {c}_{x} ) + ( {g}_{1} + … + {g}_{x} ) + \\ ( {s}_{1} + … + {s}_{x} ) + ( {t}_{1} + … + {t}_{x} ) + ( {o}_{1} + … + {o}_{x} )$$

$$D = R + ( {ra}_{1} + … + {ra}_{x} ) + ( {rn}_{1} + … + {rn}_{x} ) or {R}_{c} or {R}_{r}$$

$${P}_{p} = ( {P}_{1} + … {P}_{x} ) - ( {D}_{1} + … {D}_{x} )$$

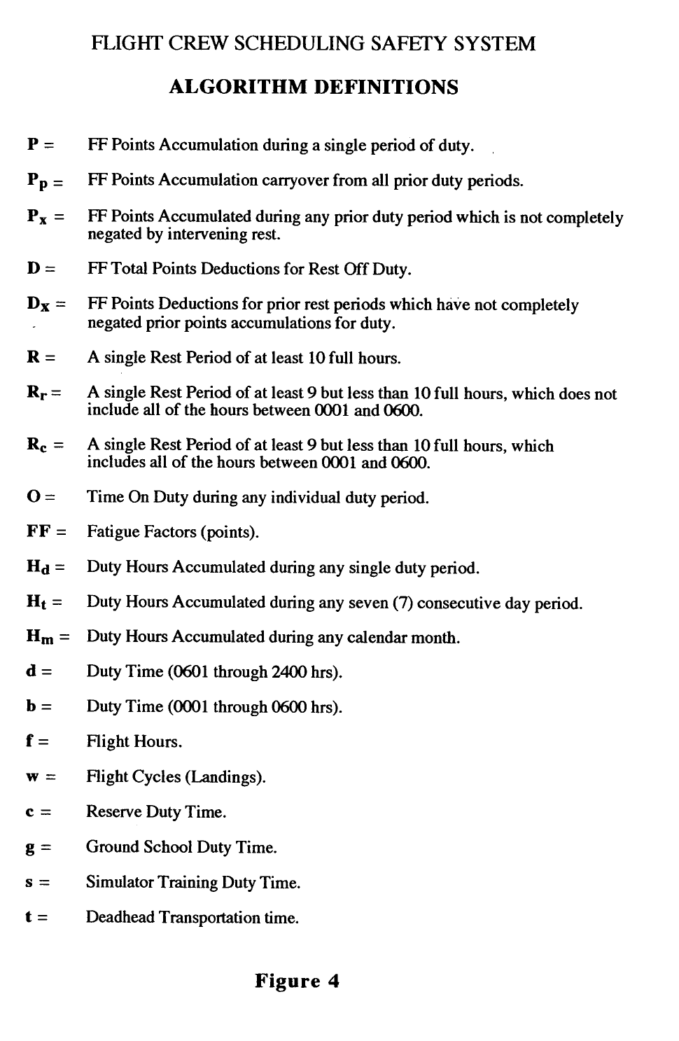

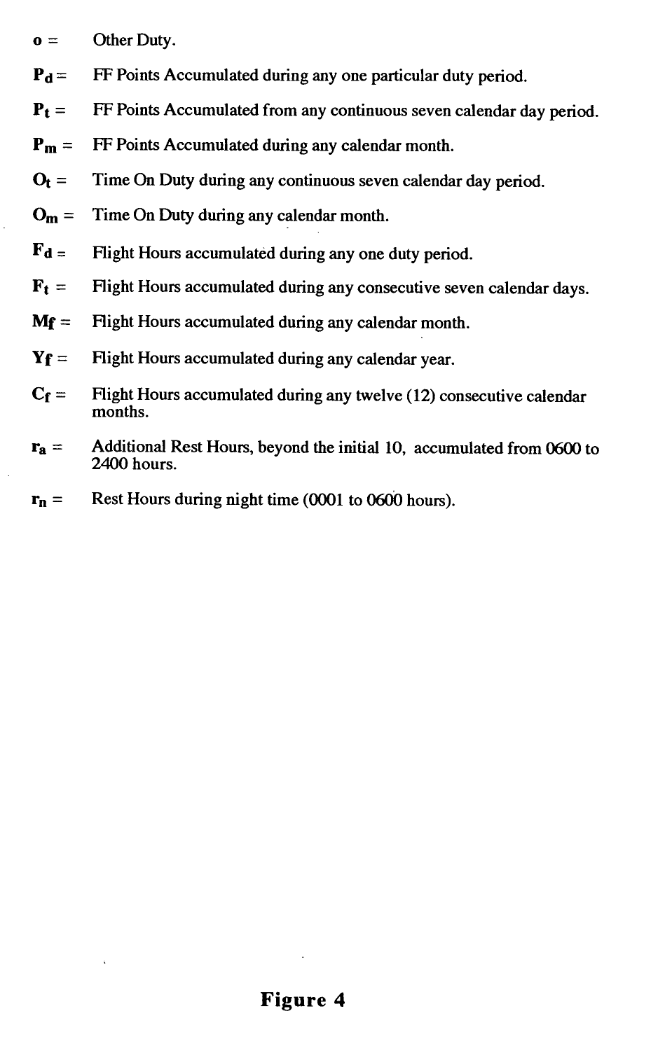

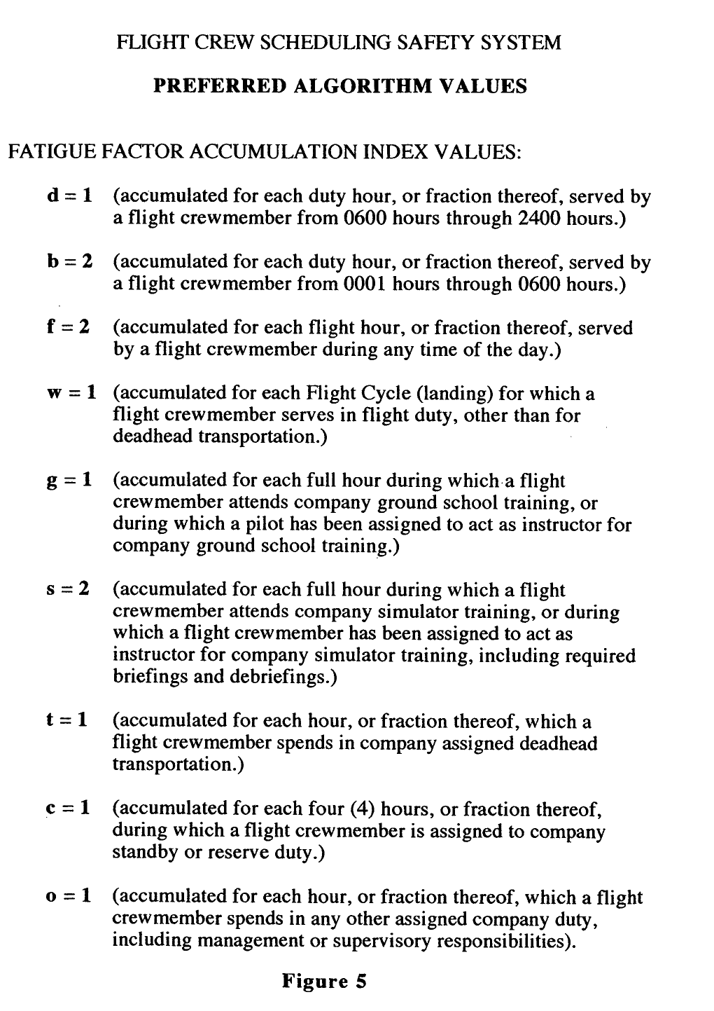

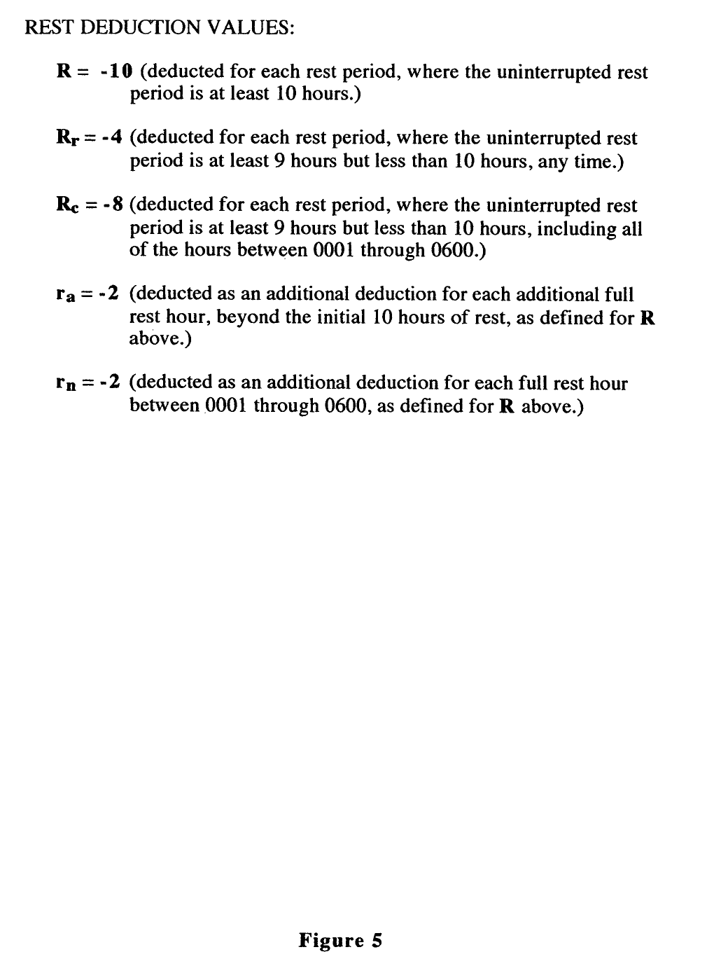

These algorithms follow the definitions which are set forth within FIG. 4. However, the ultimate computations may be accomplished in any order, using any computation methodology which results in a determination of Accumulated Fatigue Factors versus Rest Factor Reductions.

C. Rest Factor Computation:

The computation of Rest Factors is substantially the same for both a computer system and by means of a manual worksheet. The description here is provided for the manual Rest Factors Computational Worksheet (FIG. 8). However, this methodology is equally valid in any computer based system, as a standalone program, as a subroutine in an existing scheduling optimization system, in a spreadsheet program, or in a database program.

Step 1

Accumulated Fatigue Factors are first transferred from the prior Fatigue Factor computations. From the manual Fatigue Factors Computational Worksheet, the Accumulated Points are transferred from Line 11 (FIG. 7; Line 11). (Any number of porting methodologies are available for transfer or porting the data from computer-based records-keeping systems). This is the base figure against which Rest Deductions will be subtracted.

Steps 2-3

In the first Rest Reduction computation, there are data entries for the Rest Period End Time and the Rest Period Start Time. This may be accomplished using any consistent time system where there is an allowance for time zone differences and the ability to calculate necessary local times. The Start Time is then subtracted from the End time to obtain a value for the Total Rest period. (Rest Period End Time)−(Rest Period Start Time)=Total Rest Period. Under the preferred methodology, for evaluation purposes, any fractional hour value is rounded down to the next lower whole hour.

Step 4

In both the computer and manual systems, a logical evaluation then takes place as an 'If . . . Then” logical assessment. First, “If” the Rest Period is greater than or equal to nine (9), “Then” the period under evaluation is determined to be a “VALID” rest period for purposes of the Rest Period Reduction Computation (See: FIG. 8). A result equal to or greater than nine (9) allows the computation to continue.

Step 5

Under the preferred system methodology, for this Sample Embodiment, the second logical evaluation is whether or not the Total Rest Period was less than ten (10) hours. (This computation and evaluation can be accomplished in any number of alternate ways). If the Total Rest Period was nine (9) or more, but less than ten (10) hours, the Rest Reduction value index will be one of two values. With respect to the entered Rest Start and End Times, a logical determination is made as to whether or not that rest period included ALL of the hours between 0000 and 0600 hours (Local Time at the station where a crewmember began his/her most recent duty period). If all such hours were included in the Rest Period, the preferred Rest Reduction index value is a minus eight (−8). If all hours between 0000 hours and 0600 hours were not a part of the Rest Period, then the preferred Rest Reduction index value is a minus four (−4).

Steps 6 and Beyond

Under the circumstances where a flight crewmember received nine (9) or more hours of rest, but less than ten (10) hours of rest, the only other computation which is necessary is to subtract the resultant value from the Prior Accumulated Fatigue Factors (FIG. 8, Line 6). The result of this subtraction will provide the Total Accumulated Fatigue Factors, if any, which are carried over for evaluation of planned or actual subsequent duty periods. The routine ends with an entry in the Fatigue Factor Accumulation Register, or with the transferal of the Fatigue Factor Accumulation value to a subsequent Fatigue Factor Accumulation Worksheet.

In the event that a flight crewmember receives ten (10) or more hours of continuous rest, between two periods of carrier duty, additional calculations are necessary to determine the added value benefit of the additional rest. The Initial Ten (10) hours of rest is valued at minus ten (−10) and entered on the Rest Reduction Worksheet (FIG. 8) or transferred to the Rest Reduction Accumulation Register in the computer system.

Under this ten (10) or more hour scenario for the Sample Embodiment, each additional full hour of rest, beyond the initial ten (10) hours, is multiplied time minus two (−2), the preferred Additional Rest Reduction value index, to determine the Additional Rest Reduction value. This additional value is then entered on the Rest Reduction Worksheet (FIG. 8) or transferred to the Rest Reduction Accumulation Register in the computer system.

Under the ten (10) or more hour scenario, each additional full hour between the hours of 0000 to 0600 is provided an added Rest Reduction value. For each full hour, where preferred methodology rounds fractional hours to the next lower full hour, each additional full hour of rest is multiplied by the preferred Diurnal Rest Reduction value index of minus two (−2). This result is then entered on the Rest Reduction Worksheet (FIG. 8) or transferred to the Rest Reduction Accumulation Register in the computer system.

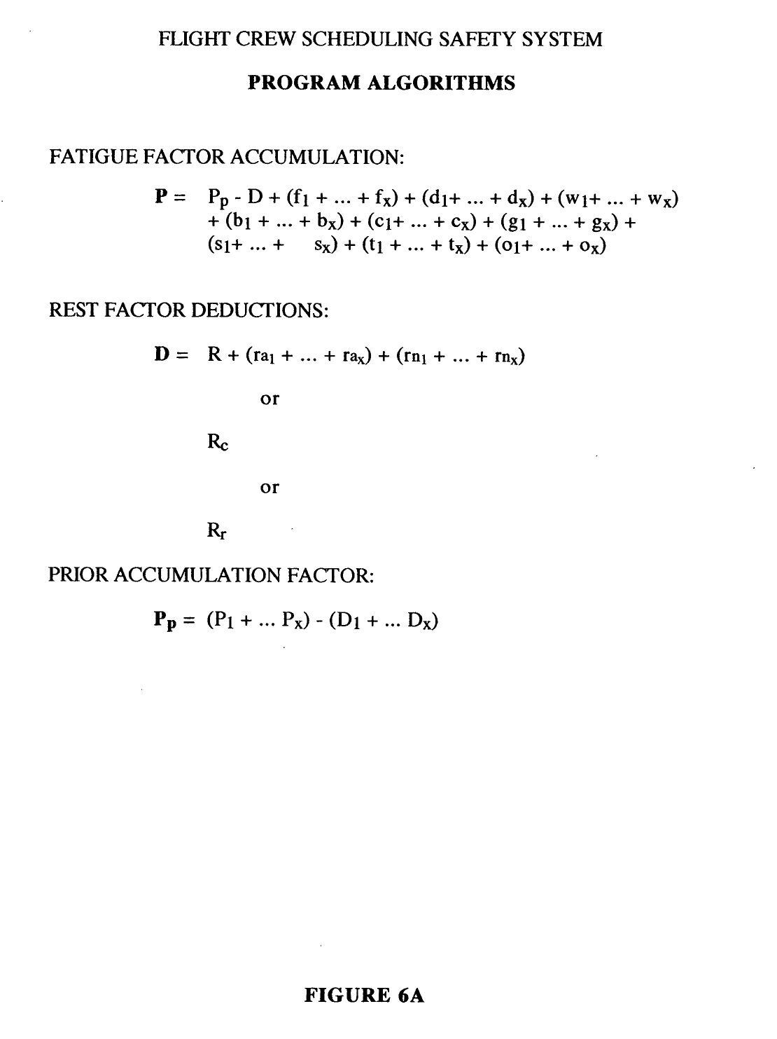

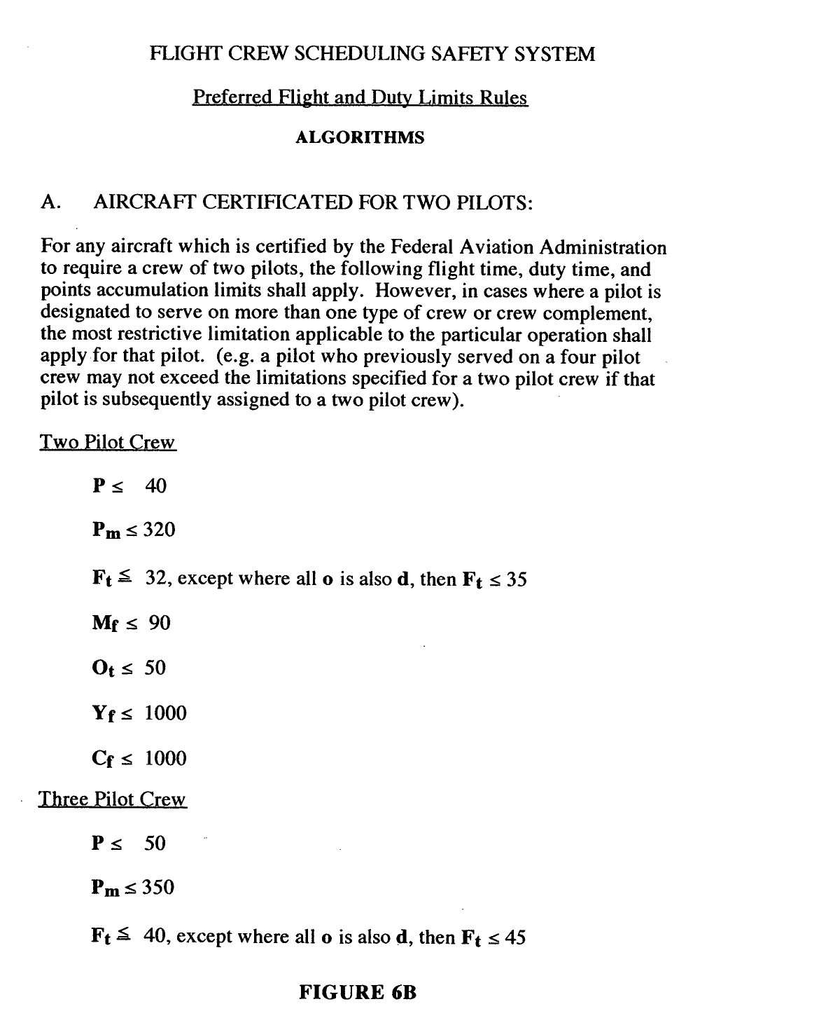

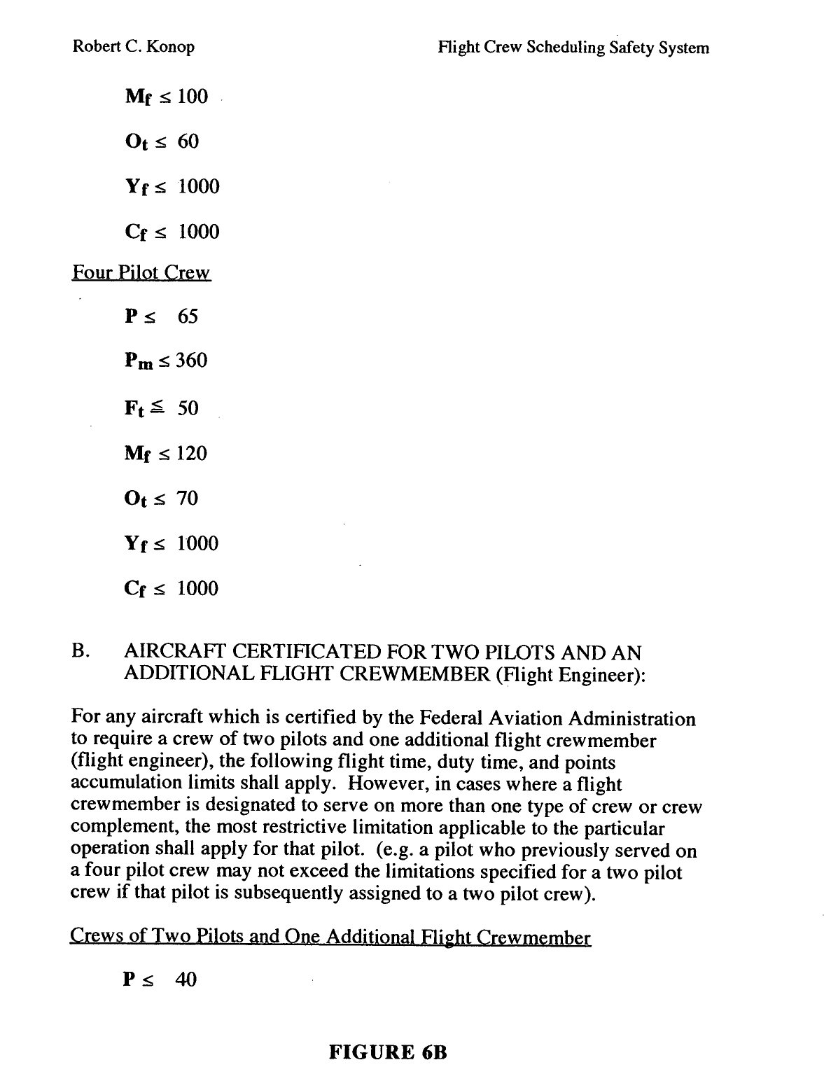

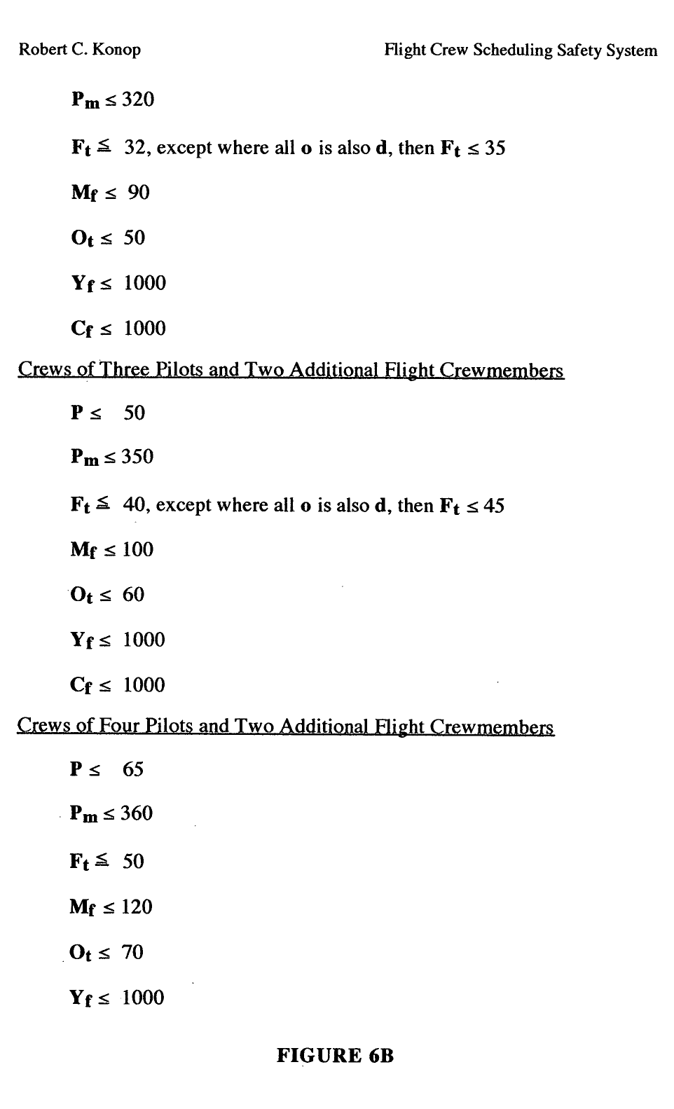

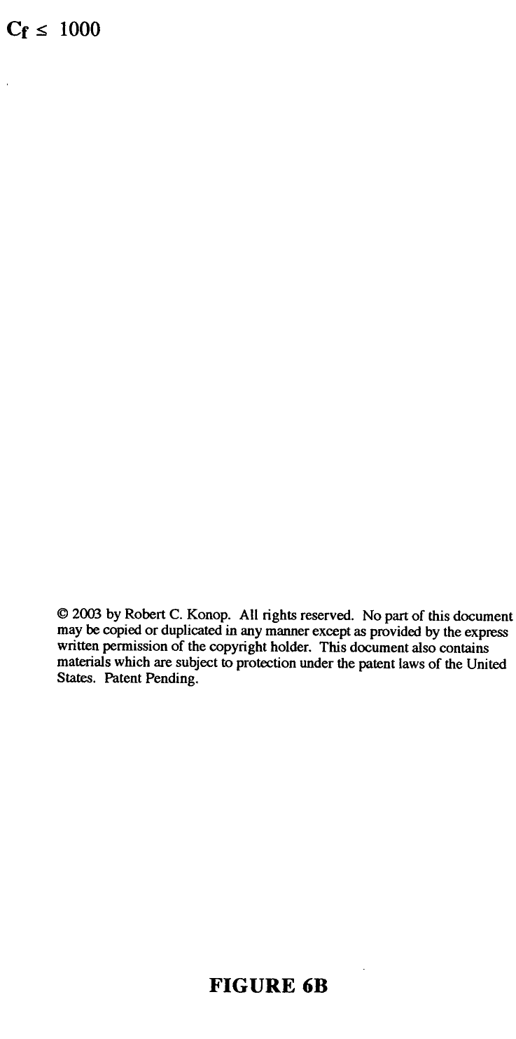

Under the ten (10) or more hour scenario, the results for the Initial Ten hour Rest Reduction value is summed with the Additional Rest Reduction value and the Diurnal Rest Reduction value (FIG. 8, Line 5). This result, a negative number, is then summed (subtracted from) with the accumulated Fatigue Factors which were determined for the prior period of carrier duty (FIG. 6, Line 1; or the prior Fatigue Factor Accumulation Worksheet). Where the result is a negative number, the value shall be zero (0).

In this manner, the sum of accumulated Fatigue Factors is reduced through intervening Rest Reduction Factors. Under the preferred system, the numerical value of the Fatigue Factor Carryover, determines the type and amount of additional duty which a flight crewmember will be allowed to undertake during subsequent periods of carrier duty.

Advantages and Scope of Invention

As is readily apparent, the system and method of the present invention is advantageous in several respects. Through the use of the methodology, dangerous levels of human fatigue can be avoided. The system also aides in the avoidance of situations in which the accumulation of diverse Fatigue Factors will reduce productivity. The methodology further allows for more scheduling flexibility, considering a range of Fatigue Factors affecting performance, rather than placing an arbitrary limitation based upon work hours and/or duty hours in isolation. The consideration of this range of factors will ultimately serve to enhance both productivity and safety.

Conclusion and Ramifications

The Human Factors Scheduling Safety System addresses an area of schedule planning, implementation, execution, and the schedule records-keeping process which has previously been overlooked, other than with respect to the arbitrary limitation of work and/or duty hours. A comprehensive Fatigue Factor evaluation process, measured against prior and subsequent Rest Factor amelioration, provides a means to both enhance safety while allowing an opportunity to optimize productivity.

Thus the scope of the invention should be determined by the appended claims and their legal equivalents, rather than by the examples which have been given.

[image]

[image]

[image]

[image]

[image]

[image]

[image]

[image]

[image]

[image]

1. A method of scheduling personnel comprising:
(a) an investigation of each of the factors which will induce fatigue in the personnel during work time, and determining the relative impact of each such Fatigue Factor.
(b) a determination of the safety and/or productivity limits of accumulated Fatigue Factors for a particular job function.
(c) a summation of all accumulated Fatigue Factors values as relates to a particular work task, or series of work tasks.
(d) an application of the safety and/or productivity limits determined for the particular work task, or series of work tasks, whereby such tasks, or planned tasks, are discontinued prior to reaching a level of accumulated Fatigue Factors which will adversely impact safety and/or productivity.
(e) a tabulation of the total Fatigue Factor values, accumulated during any particular work period and/or work task.
(f) an investigation of each of the Rest Factors which will ameliorate accumulated Fatigue Factors in individuals in rest periods between assigned periods of work time.
(g a determination of the intervening rest period, in terms of duration and quality of Rest and Rest Factors, which will sufficiently ameliorate previously accumulated Fatigue Factors to allow a subsequent return to work for an additional full or partial work period.
(h) a subtration of accumulated Rest Factor values, from previously accumulated Fatigue Factor values, to determine residual fatiuge, if any, which is carried forward to any subsequent work period from any prior work period or periods.
(i) a rejection of any rest period in which the ameliorating Rest Factors values are insufficient to allow a subsequent return to work for an additional full or partial work period, as determined by investigation.
